(19) United States
(12) Patent Application Publication
(10) Pub. No.: US 2025/0385336 A1
(43) Pub. Date: Dec. 18, 2025

(54) BATTERY CELL WITH ONE OR MORE BARRIER COATINGS

(71) Applicant: GM Global Technology Operations LLC, Detroit, MI (US)

(72) Inventors: Fengkun Wang, Rochester Hills, MI (US); Taylor Reed Garrick, Bloomfield Hills, MI (US); Ryan Patrick Hickey, Austin, TX (US)

(73) Assignee: GM Global Technology Operations LLC, Detroit, MI (US)

(21) Appl. No.: 18/744,607

(22) Filed: Jun. 15, 2024

(51) Int. Cl. H01M 10/653; B60L 50/64; H01M 10/04; H01M 10/0587; H01M 50/103; H01M 50/105; H01M 50/107; H01M 50/124; H01M 50/209; H01M 50/211; H01M 50/213; H01M 50/383

(52) U.S. Cl. CPC H01M 10/653; B60L 50/64; H01M 10/0431; H01M 10/0587; H01M 50/103; H01M 50/105; H01M 50/107; H01M 50/124; H01M 50/209; H01M 50/211; H01M 50/213; H01M 50/383; H01M 2220/20

(57) ABSTRACT

A battery cell including a main body, the main body having an inner wall defining a chamber and an outer wall opposite the inner wall. The battery cell further including battery internals arranged in the chamber and one or more barrier coatings arranged on at least one of the inner wall and the outer wall. The one or more barrier coatings having a first thermal conductivity at a first thermal condition and a second thermal conductivity at a second thermal condition.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to an electrical battery pack and, more particularly, to a battery cell with one or more barrier coatings.

In general, electric vehicles can be equipped with a battery pack that includes one or more battery cells. Lithium-ion batteries are typically used in vehicles due to their high energy and power densities. Sometimes, however, a chain of uncontrolled exothermic reactions can occur within the lithium-ion batteries (i.e., thermal runaway). These reactions can result in a rise in internal temperature of the battery that causes inner structures of the battery to destabilize and degrade and eventually lead to failure of the battery. Some batteries or battery packs include thermal runaway propagation management systems, but they either take up a large amount of space or are ineffective during a thermal runaway scenario. Shortcomings of existing systems and methods are addressed by one or more aspects of the present disclosure.

### SUMMARY

According to one configuration, a battery cell is provided and includes a main body including an inner wall defining a chamber and an outer wall opposite the inner wall. The battery cell further includes battery internals arranged in the chamber. The battery cell further includes one or more barrier coatings arranged on at least one of the inner wall and the outer wall, the one or more barrier coatings including a first thermal conductivity at a first thermal condition and a second thermal conductivity at a second thermal condition.

The battery cell includes one or more of the following optional aspects. For example, the main body can be one of a cylindrical cell, a pouch cell, or a prismatic cell.

According to at least one aspect, the battery internals can further include one or more jelly rolls.

According to another aspect, at least one of the one or more barrier coatings includes a porous medium at the second thermal condition.

According to at least one example, the first thermal conductivity is greater than 2 W/mK at the first thermal condition and less than 0.2 W/mK at the second thermal condition. The first thermal condition can be a temperature less than 75° C. and the second thermal condition can be a temperature greater than 100° C.

According to another example, the one or more barrier coatings can include a first inner layer on the inner wall and a first outer layer on the outer wall. The first inner layer and the first outer layer can be made of the same material.

According to at least one aspect, the one or more barrier coatings can include a first layer, a second layer, and third layer on both the inner wall and the outer wall. The first layer, the second layer, and the third layer can each include at least one of a dielectric material, a thermal transition material, and a fire retardant material.

According to another configuration, a battery pack is provided and includes a tray extending along a first direction, one or more battery module receptacles spaced axially along the first direction, and one or more battery modules arranged in the one or more battery module receptacles. The battery pack can further include one or more barrier coatings arranged on at least a portion of the tray and the one or more battery module receptacles, at least one of the one or more barrier coatings includes a first thermal conductivity at a first thermal condition and a second thermal conductivity at a second thermal condition.

The battery pack includes one or more of the following optional aspects. For example, at least one of the one or more barrier coatings includes a porous medium at the second thermal condition.

According to at least one aspect, the first thermal conductivity can be greater than 2 W/mK at the first thermal condition and less than 0.2 W/mK at the second thermal condition. The first thermal condition can be a temperature less than 75° C. and the second thermal condition can be a temperature greater than 100° C.

According to another aspect, the one or more barrier coatings can include a dielectric material, a thermal transition material, and a fire retardant material.

In another configuration, a vehicle is provided and includes a vehicle body and a battery pack including one or more battery modules and coupled to the vehicle body. One or more battery cells are arranged in the one or more battery modules and include a main body including an inner wall defining a chamber and an outer wall opposite the inner wall. The one or more battery cells further including battery internals arranged in the chamber. The one or more battery cells further including one or more barrier coatings arranged on at least a portion of the main body. The one or more barrier coatings including a dielectric material that insulates the main body and a thermal transition material that defines a medium with a first thermal conductivity that is greater than 2 W/mK at a first thermal condition and a second thermal conductivity that is less than 0.2 W/mK at a second thermal condition.

The vehicle includes one or more of the following optional aspects. For example, the thermal transition material can include a porous medium at the second thermal condition. The first thermal condition can be a temperature less than 75° C. and the second thermal condition can be a temperature greater than 100° C.

According to at least one aspect, the dielectric material and the thermal transition material are arranged as a single layer on the main body.

According to another aspect, the dielectric material and the thermal transition material can be arranged as adjacent layers on the main body.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a battery pack according to principles of the present disclosure;

FIG. 2 is a perspective view of the battery pack of FIG. 1 including one or more battery modules that have one or more battery cells;

FIG. 3A is a cross-sectional view of one of the one or more battery cells of FIG. 2 including a can and one or more barrier coating layers according to a first configuration;

FIG. 3B is a close-up view of the can and the one or more barrier coating layers of the battery cell of FIG. 3A subject to a first thermal condition;

FIG. 3C is a close-up view of the can and the one or more barrier coating layers of the battery cell of FIG. 3A subject to a second thermal condition;

FIG. 4A is a cross-sectional view of one of the one or more battery cells of FIG. 2 including a can and one or more barrier coating layers according to a second configuration;

FIG. 4B is a close-up view of the can and the one or more thermal barrier coating layers of the battery cell of FIG. 4A subject to a first thermal condition; and

FIG. 4C is a close-up view of the can and the one or more thermal barrier coating layers of the battery cell of FIG. 4A subject to a second thermal condition.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

In the event of a thermal runaway scenario, more than one battery cell and sometimes, more than one battery module, are affected. System failure and/or costly damage to a vehicle can occur during a thermal runaway scenario absent a thermal runaway propagation (TRP) management system. The TRP management systems can be costly and take up a significant amount of space within the vehicle. Accordingly, these shortcomings, among others, are addressed by principles of the present disclosure.

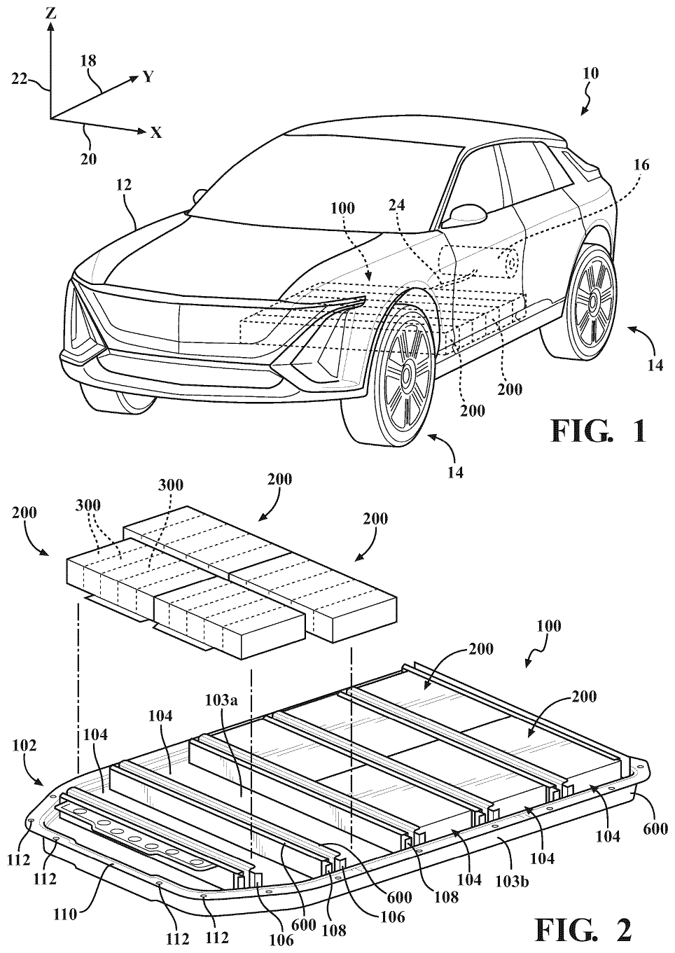

With reference to FIG. 1, a vehicle 10, such as an electric motor vehicle, is provided. The vehicle 10, includes a vehicle body 12, one or more wheels 14, and an electric motor 16 arranged in and/or coupled to the vehicle body 12. The vehicle body 12 extends along a first or longitudinal axis (i.e., fore-aft direction) 18, a second or lateral axis (i.e., cross-car direction) 20, and a third or vertical axis 22. The electric motor 16 can be configured to drive one or more of the one or more wheels 14 to propel the vehicle 10. The vehicle 10 includes a battery pack 100 that can be arranged in and/or coupled to the vehicle body 12 and is communicatively coupled to the electric motor 16 via an electric power cable 24.

With reference to FIG. 2, the battery pack 100 is shown including a tray 102 extending along the first axis 18 (FIG. 1). The tray 102 can include an inner surface 103a and an outer surface 103b opposite the inner surface 103a. One or more battery module receptacles 104 can be arranged on or can be coupled to the tray 102. The one or more battery module receptacles 104 can be configured to receive one or more battery modules 200. For instance, each of the one or more battery module receptacles 104 can include a first restraint or rail 106 and a second restraint or rail 108 that is spaced from and is parallel to the first restraint 106. The first and second restraints 106, 108 can be coupled to and extend along the tray 102 with respect to the second axis 20. In general, the first and second restraints 106, 108 can be configured secure one or more of the battery modules 200 as well as separate the one or more of the battery modules 200 from other battery modules 200 within the battery pack 100. The tray 102 can further include a flange 110 extending from the tray 102 and having one or more fastener holes 112. A tray cover (not shown) can be arranged on the tray 102 and fastened to the fastener holes 112 with one or more fasteners (not shown), for example.

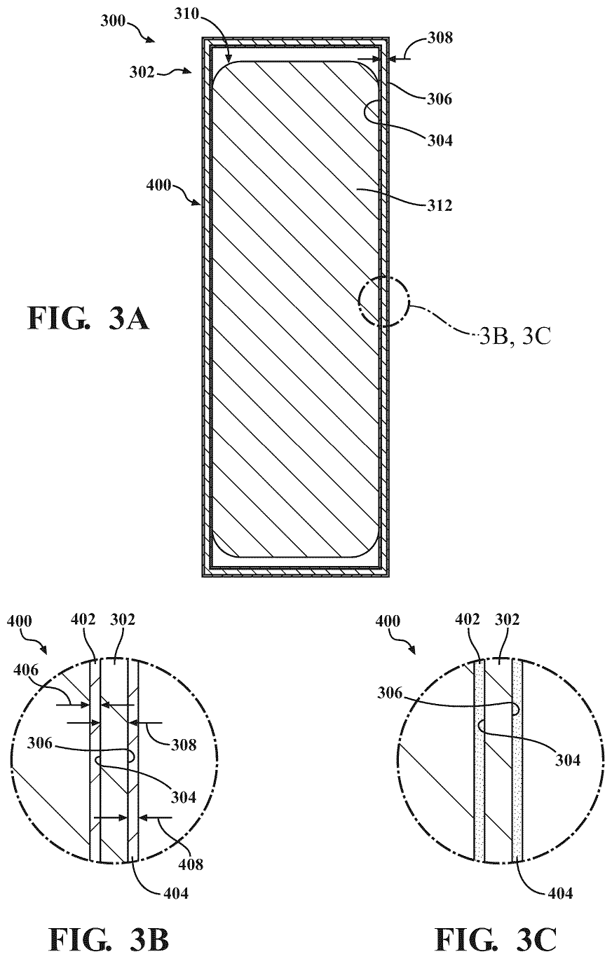

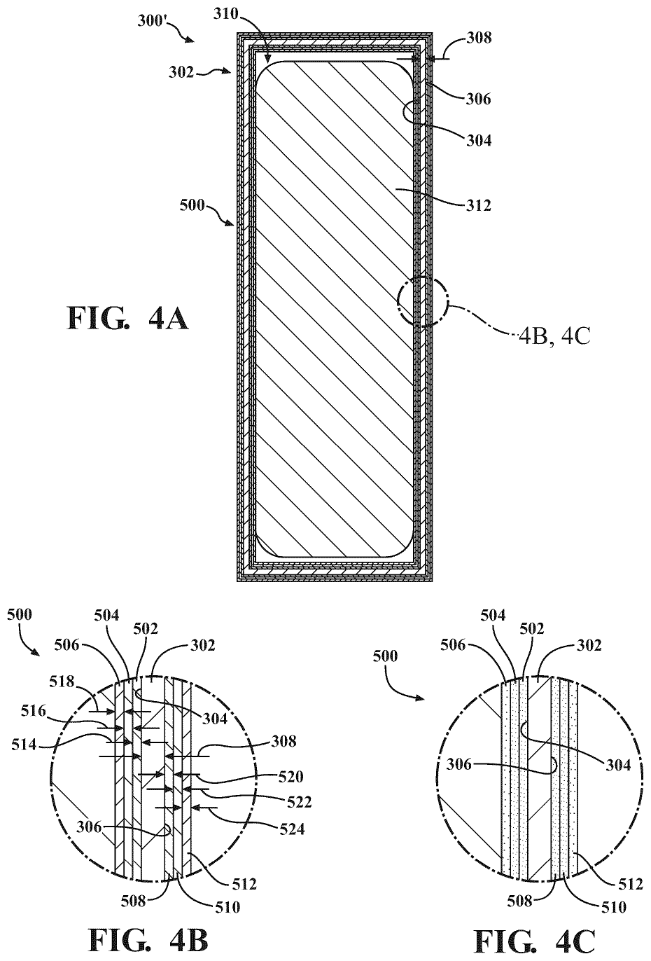

One or more battery cells 300 can be arranged in the one or more battery modules 200, as shown in FIG. 2. With reference to FIG. 3A, the one or more battery cells 300 can include a main body 302 (e.g., a prismatic can) that has an inner wall 304 and an outer wall 306 opposite the inner wall 304. The main body 302 can be made of an aluminum alloy, stainless steel, or another material commonly used for battery cells of a vehicle. A thickness 308 can be defined between the inner wall 304 and the outer wall 306. The inner wall 304 defines a chamber 310 that is configured to receive and/or house battery internals, such as one or more jelly rolls 312, for example. According to one aspect, the battery cells 300 can be prismatic cells, cylindrical cells, or pouch cells. Illustrative examples of prismatic cells are provided in FIGS. 3A and 4A and referenced throughout the present disclosure, but the principles of the present disclosure equally apply to cylindrical cells, pouch cells, and other battery cells that can be used in a vehicle.

With reference to FIGS. 3A and 3B, the battery cell 300 can include one or more barrier coatings 400 arranged on at least a portion of the main body 302. The one or more barrier coatings 400 can be desirable for thermal runaway propagation management, electrical insulation, and/or fire retardation, for example. With reference to FIG. 3B, the one or more barrier coatings 400 can include a first inner layer 402 applied to (e.g., via spray, mist, etc.) or arranged on (i.e., coupled to) the inner wall 304. Additionally or alternatively, the one or more barrier coatings 400 can include a first outer layer 404 applied to (e.g., via spray, mist, etc.) or arranged on (i.e., coupled to) the outer wall 306. One or both of the first inner layer 402 and the first outer layer 404 include a thermal transition material that includes a first thermal conductivity at a first thermal condition (e.g., a first temperature) and a second thermal conductivity at a second thermal condition (e.g., a second temperature). In other words, if the battery cell 300 is operating under normal conditions and has an internal temperature of less than 75° C., then the first inner layer and/or the first outer layer have the first thermal conductivity (e.g., greater than 2 W/mK). However, as shown in FIG. 3C, in the event of a thermal runaway scenario where the internal temperature of the battery cell 300 exceeds 75° C. (e.g., 100° C.), a phase change or evaporation of the first inner layer 402 and/or the first outer layer 404 is triggered (i.e., initiated) that leads to expansion of one or both of the layers 402, 404 and formation of at least one porous medium with low thermal conductivity. As a result, the first inner layer 402 and/or the first outer layer 404 has the second thermal conductivity (e.g., less than 0.2 W/mK).

The first inner layer 402 can have a first inner layer thickness 406 and the first outer layer 404 can have a first outer layer thickness 408. The first inner layer thickness 406 and the first outer layer thickness 408 can be the same or different to facilitate a desired heat transfer pathway away from or within the battery cell 300, for example. According to at least one aspect, the first inner layer 402 and/or the first outer layer 404 can be made of the same material. Additionally, the first inner and outer layers 402, 404 can further include a dielectric material and/or a fire retardant material in addition to the transition material introduced above. According to another aspect, the one or more barrier coatings 400 can be hydrophilic (e.g., cellulose based, lignin based, etc.). Including a hydrophilic material may be desirable so that the one or more barrier coatings 400 can absorb and/or release water from the battery internals (e.g., an electrolyte) during normal operation and during a thermal runaway scenario. Particularly, the hydrophilic material can be configured to scavenge water during normal operation of the battery cell 300 (i.e., improving battery performance) and can release water during a thermal runaway scenario (i.e., providing an evaporative barrier).

During operation, the one or more barrier coatings 400 on the inner wall 304 of the main body 302 (e.g., prismatic can) can enhance heat transfer away from the cell (e.g., to a coolant) during normal conditions and can prevent or delay the main body 302 from melting during a thermal runaway scenario. Additionally, the one or more barrier coatings 400 on the inner wall 304 of the main body 302 can prevent hot particles that would ordinarily fall on and affect adjacent battery cells 300 within the battery module 200. In other words, the one or more barrier coatings 400 on the inner wall 304 can eliminate the need for a thermal runaway propagation management system at a module level (i.e., between the one or more battery cells 300 of the battery modules 200). Additionally or alternatively, the one or more barrier coatings 400 on the outer wall 306 of the main body 302 can form a protection layer with low thermal conductivity at high temperatures (i.e., during a thermal runaway scenario) which can decrease heat transfer from vent particles affecting neighboring cells and/or modules of the battery pack 100.

FIGS. 4A, 4B, and 4C illustrate another illustrative configuration of a battery cell 300′. This configuration is similar in many respects to the configuration of FIGS. 3A, 3B, and 3C. Accordingly, the descriptions of the configurations are hereby incorporated into one another, and description of subject matter common to the configurations generally may not be repeated.

With reference to FIGS. 4A and 4B, the battery cell 300′ can include one or more barrier coatings 500 arranged on a portion of the main body 302. The one or more barrier coatings 500 can be desirable for thermal runaway propagation management, electrical insulation, and/or fire retardation, for example. With reference to FIG. 4B, the one or more barrier coatings 500 can include a first inner layer 502 on the inner wall 304, a second inner layer 504 adjacent the first inner layer 502, and a third inner layer 506 adjacent the second inner layer 504. Additionally or alternatively, the one or more barrier coatings 500 can include a first outer layer 508 adjacent the outer wall 306, a second outer layer 510 adjacent the first outer layer 508, and a third outer layer 512 adjacent the second outer layer 510. The inner layers 502, 504, 506 and/or the outer layers 508, 510, 512 can be applied to the main body 302 via spraying, misting, dipping, etc. The inner layers 502, 504, 506 and/or the outer layers 508, 510, 512 can include a thermal transition material that includes a first thermal conductivity at a first thermal condition (e.g., a first temperature) and a second thermal conductivity at a second thermal condition (e.g., a second temperature). In other words, if the battery cell 300′ is operating under normal conditions and has an internal temperature of less than 75° C., then the inner layers 502, 504, 506 and/or the outer layers 508, 510, 512 have the first thermal conductivity (e.g., greater than 2 W/mK). However, as shown in FIG. 4C, in the event of a thermal runaway scenario where the internal temperature of the battery cell 300′ exceeds 75° C. (e.g., about 100° C.), a phase change or evaporation of the inner layers 502, 504, 506 and/or the outer layers 508, 510, 512 is triggered that leads to expansion of one or all of the layers 502, 504, 506, 508, 510, 512 and formation of at least one porous medium with a low thermal conductivity. As a result, the inner layers 502, 504, 506 and/or the outer layers 508, 510, 512 layers have the second thermal conductivity (e.g., less than 0.2 W/mK).

The first inner layer 502 can have a first inner layer thickness 514, the second inner layer 504 can have a second inner layer thickness 516, and the third inner layer 506 can have a third inner layer thickness 518. Similarly, the first outer layer 508 can have a first outer layer thickness 520, the second outer layer 510 can have a second outer layer thickness 522, and the third outer layer 512 can have a third outer layer thickness 524. The thicknesses of the inner layer 502, 504, 506 and the outer layers 508, 510, 512 can be the same or different to facilitate a desired heat transfer pathway away from or within the battery cell 300′, for example. According to at least one aspect, the first inner layer 502 and/or the first outer layer 508 can be made of a first material, the second inner layer 504 and the second outer layer 510 can be made of a second material, and the third inner layer 506 and the third outer layer 512 can be made of a third material.

Additionally, the inner layers 502, 504, 506 and/or the outer layer 508, 510, 512 can further include a dielectric material and/or a fire retardant material in addition to the transition material introduced above. According to another aspect, the one or more barrier coatings 500 can be hydrophilic (e.g., cellulose based, lignin based, etc.). Including a hydrophilic material may be desirable so that the one or more barrier coatings 500 can absorb and/or release water from the battery internals (e.g., an electrolyte) during normal operation and during a thermal runaway scenario. Particularly, the hydrophilic material can be configured to scavenge water during normal operation of the battery cell 300′ (i.e., improving battery performance) and can release water during a thermal runaway scenario (i.e., providing an evaporative barrier).

In another illustrative configuration, instead of the battery cells 300, 300′ including the one or more barrier coatings 400, 500, the tray 102 and/or the corresponding tray cover (not shown) can include one or more barrier coatings 600. This configuration is similar in many respects to the configurations of FIGS. 3A-3C and 4A-4C and the one or more barrier coatings 600 include the one or more barrier coatings 400, 500 described in the aforementioned configuration. Accordingly, the descriptions of the configurations are hereby incorporated into one another, and description of subject matter common to the configurations generally may not be repeated.

The one or more barrier coatings 600 can be applied to the tray 102 and/or the tray cover to serve as a thermal barrier and/or a protection layer for the battery pack 100. The one or more barrier coatings can be applied to the inner surface 103a and/or the outer surface 103b of the tray 102. This may be desirable to decrease heat transfer from inside to outside of the tray 102 during a thermal runaway scenario. Additionally or alternatively, a thick coating of the one or more barrier coatings 600 can be applied to the outer surface 103b to protect the battery pack 100 from extreme road conditions. According to another aspect, the thickness of the one or more barrier coatings 600 can vary to facilitate a desired heat transfer pathway away from or within the battery pack 100, for example. The one or more barrier coatings 600 can additionally or alternatively be applied to the first and second restraint rails 104, 106. This may be desirable to decrease heat transfer to neighboring battery modules 200 during a thermal runaway scenario.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A battery cell, comprising:
a main body, comprising:
an inner wall defining a chamber, and
an outer wall opposite the inner wall;
battery internals arranged in the chamber; and
one or more barrier coatings arranged on at least one of the inner wall and the outer wall, the one or more barrier coatings comprising a first thermal conductivity at a first thermal condition and a second thermal conductivity at a second thermal condition.

2. The battery cell of claim 1, wherein the main body is one of a cylindrical cell, a pouch cell, or a prismatic cell.

3. The battery cell of claim 1, wherein the battery internals further comprise one or more jelly rolls.

4. The battery cell of claim 1, wherein at least one of the one or more barrier coatings includes a porous medium at the second thermal condition.

5. The battery cell of claim 1, wherein the first thermal conductivity is greater than 2 W/mK at the first thermal condition and less than 0.2 W/mK at the second thermal condition.

6. The battery cell of claim 5, wherein the first thermal condition is a temperature less than 75° C. and the second thermal condition is a temperature greater than 100° C.

7. The battery cell of claim 5, wherein the one or more barrier coatings includes a first inner layer on the inner wall and a first outer layer on the outer wall.

8. The battery cell of claim 7, wherein the first inner layer and the first outer layer comprise the same material.

9. The battery cell of claim 5, wherein the one or more barrier coatings includes a first layer, a second layer, and third layer on both the inner wall and the outer wall.

10. The battery cell of claim 9, wherein the first layer, the second layer, and the third layer can each include at least one of a dielectric material, a thermal transition material, and a fire retardant material.

11. A battery pack, comprising:
a tray extending along a first direction;
one or more battery module receptacles spaced axially along the first direction;
one or more battery modules arranged in the one or more battery module receptacles; and
one or more barrier coatings arranged on at least a portion of the tray and the one or more battery module receptacles, at least one of the one or more barrier coatings comprises a first thermal conductivity at a first thermal condition and a second thermal conductivity at a second thermal condition.

12. The battery pack of claim 11, wherein at least one of the one or more barrier coatings includes a porous medium at the second thermal condition.

13. The battery pack of claim 11, wherein the first thermal conductivity is greater than 2 W/mK at the first thermal condition and less than 0.2 W/mK at the second thermal condition.

14. The battery pack of claim 13, wherein the first thermal condition is a temperature less than 75° C. and the second thermal condition is a temperature greater than 100° C.

15. The battery pack of claim 11, wherein the one or more barrier coatings includes a dielectric material, a thermal transition material, and a fire retardant material.

16. A vehicle, comprising:
a vehicle body;
a battery pack including one or more battery modules and coupled to the vehicle body,
one or more battery cells arranged in the one or more battery modules, comprising:
a main body, comprising:
an inner wall defining a chamber, and
an outer wall opposite the inner wall;
battery internals arranged in the chamber; and
one or more barrier coatings arranged on at least a portion of the main body, comprising:
a dielectric material that insulates the main body; and
a thermal transition material that defines a medium with a first thermal conductivity that is greater than 2 W/mK at a first thermal condition and a second thermal conductivity that is less than 0.2 W/mK at a second thermal condition.

17. The vehicle of claim 16, wherein the thermal transition material includes a porous medium at the second thermal condition.

18. The vehicle of claim 17, wherein the first thermal condition is a temperature less than 75° C. and the second thermal condition is a temperature greater than 100° C.

19. The vehicle of claim 16, wherein the dielectric material and the thermal transition material are arranged as a single layer on the main body.

20. The vehicle of claim 16, wherein the dielectric material and the thermal transition material are arranged as adjacent layers on the main body.
